(19) United States
(12) Patent Application Publication
(10) Pub. No.: US 2024/0221248 A1
(43) Pub. Date: Jul. 4, 2024

(54) METHODS AND SYSTEMS FOR SPECTRAL IMAGING

(71) Applicant: SHANGHAI UNITED IMAGING HEALTHCARE CO., LTD., Shanghai (CN)

(72) Inventors: Meili YANG, Shanghai (CN); Jianwei FU, Shanghai (CN)

(73) Assignee: SHANGHAI UNITED IMAGING HEALTHCARE CO., LTD., Shanghai (CN)

(21) Appl. No.: 18/401,327

(22) Filed: Dec. 29, 2023

(30) Foreign Application Priority Data
Dec. 30, 2022 (CN) 202211739850.4

(51) Int. Cl. G06T 11/00

(52) U.S. Cl. CPC G06T 11/006; G06T 11/005; G06T 2210/36; G06T 2210/41; G06T 2211/408

(57) ABSTRACT

The present disclosure is related to methods and systems for spectral imaging. The method may include obtaining scan data of a target subject, determining spectral intermediate data based on the scan data, and generating a target spectral image based on the spectral intermediate data.

### CROSS-REFERENCE TO RELATED APPLICATIONS

This application claims priority to Chinese Patent Application No. 202211739850.4, filed on Dec. 30, 2022, the entire contents of which are hereby incorporated by reference.

### TECHNICAL FIELD

The present disclosure generally relates to the field of medical imaging, and more particularly, relates to methods and systems for spectral imaging.

### BACKGROUND

X-rays produced by a tube of a conventional Computed Tomography (CT) have a continuous energy distribution. Compared with the conventional CT, multi-energy or multi-spectra CT imaging provides more image information by using various absorption of materials under different X-ray energy. For example, morphological information and energy information of a human tissue may be obtained through multi-spectral calculation, and an image representing a morphological and energy signal of the human tissue may be obtained by a CT reconstruction algorithm, thereby providing much diagnosis information to a physician. However, commonly used spectral imaging manners usually obtain a medical image by performing the image reconstruction on original raw data, which occupies much computing resources and storage space, and achieves simple functions that cannot satisfy different requirements of the physician for viewing the medical image.

Thus, it is desirable to provide methods and systems for spectral imaging, which achieves a transmission of spectral data between different devices, obtains medical images with high accuracy and quality, achieves a user interaction for adjusting an image quality, and satisfies different requirements of the physician for viewing the medical images.

### SUMMARY

An aspect of the present disclosure provides a method for spectral imaging implemented on a first processing device. The method may include obtaining scan data of a target subject, determining spectral intermediate data based on the scan data, and generating a target spectral image based on the spectral intermediate data.

In some embodiments, the spectral intermediate data may include at least one of noise spectral intermediate data or denoised spectral intermediate data.

In some embodiments, a type of the target spectral image may include at least one of a dual-base material pair image, a virtual monoenergetic image, a virtual non-contrast image, an electron density image, or an effective atomic number image.

In some embodiments, a volume of the noise spectral intermediate data or a volume of the denoised spectral intermediate data is related to the type of the target spectral image.

In some embodiments, the generating, based on the spectral intermediate data, the target spectral image may include obtaining a first processing parameter, and generating the target spectral image based on the spectral intermediate data and the first processing parameter.

In some embodiments, the first processing parameter may be related to a target noise level, and the generating, based on the spectral intermediate data and the first processing parameter, the target spectral image may include generating the target spectral image by performing a weighting operation on the spectral intermediate data based on the target noise level.

In some embodiments, the first processing parameter may be related to a type of the target spectral image, and the generating, based on the spectral intermediate data and the first processing parameter, the target spectral image may include determining first spectral processing data by using the first processing parameter to process the spectral intermediate data, and generating the target spectral image by performing a weighting operation on the first spectral processing data.

In some embodiments, the generating, based on the spectral intermediate data, the target spectral image may include for each of one or more pixels corresponding to the target subject, determining an effective atomic number value of the pixel based on the spectral intermediate data, and generating the target spectral image based on one or more effective atomic number values of the one or more pixels.

In some embodiments, the generating, based on one or more effective atomic number values of the one or more pixels, the target spectral image may include determining second spectral processing data by using a second processing parameter to process the spectral intermediate data, and generating at least two weighted images by performing a weighting operation on the second spectral processing data. The at least two weighted images may include a first weighted image and a second weighted image. The method may further include for the each of one or more pixels corresponding to the target subject, determining the effective atomic number value of the pixel based on a first pixel value in the first weighted image, a second pixel value in the second weighted image, and a correction relationship, and generating the target spectral image based on the one or more effective atomic number values of the one or more pixels. The target spectral image may be an effective atomic number image.

In some embodiments, a difference between a first energy value corresponding to the first weighted image and a second energy value corresponding to the second weighted image may satisfy a preset condition.

In some embodiments, the correction relationship may include a plurality of correction parameters, and the plurality of correction parameters may be determined by determining a plurality of reference effective atomic number values corresponding to a plurality of reference pixels of a reference subject based on the reference subject, determining a plurality of reference correction relationships based on the plurality of reference effective atomic number values, and determining the plurality of correction parameters based on the plurality of reference correction relationships.

In some embodiments, the determining, based on the plurality of reference correction relationships, the plurality of correction parameters may include determining the plurality of correction parameters by performing at least one of a fitting-processing operation or a statistical computing operation on the plurality of reference correction relationships.

In some embodiments, the method may further include generating a spectral data packet based on at least one intermediate image and the spectral intermediate data, and transmitting the spectral data packet to a second processing device by the first processing device. The first processing device may be configured to process the scan data. The method may also include generating the target spectral image by the second processing device based on the spectral data packet. The second processing device may be configured to access a service terminal.

Another aspect of the present disclosure provides a system for spectral imaging. The system may include at least one storage device storing a set of instructions and at least one processor in communication with the storage device. When executing the set of instructions, the at least one processor may be configured to cause the system to perform operations. The operations may include obtaining scan data of a target subject, determining spectral intermediate data based on the scan data, and generating a target spectral image based on the spectral intermediate data.

Another aspect of the present disclosure provides a non-transitory computer readable medium storing instructions. The instructions, when executed by at least one processor, may cause the at least one processor to implement a method. The method may include obtaining scan data of a target subject, determining spectral intermediate data based on the scan data, and generating a target spectral image based on the spectral intermediate data.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities, and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. The drawings are not to scale. These embodiments are non-limiting exemplary embodiments, in which like reference numerals represent similar structures throughout the several views of the drawings, and wherein:

FIG. 1 is a schematic diagram illustrating an exemplary imaging system according to some embodiments of the present disclosure;

FIG. 2 is a schematic diagram illustrating exemplary hardware and/or software components of a computing device according to some embodiments of the present disclosure;

FIG. 3 is a schematic diagram illustrating exemplary hardware and/or software components of a mobile device according to some embodiments of the present disclosure;

FIG. 4 is a schematic block diagram illustrating an exemplary first processing device according to some embodiments of the present disclosure;

FIG. 5 is a flowchart illustrating an exemplary process for spectral imaging according to some embodiments of the present disclosure;

FIG. 6 is a flowchart illustrating an exemplary process for generating a target spectral image according to some embodiments of the present disclosure;

FIG. 7 is a flowchart illustrating an exemplary process for generating an effective atomic number image according to some embodiments of the present disclosure;

FIG. 8A is a schematic diagram illustrating an exemplary effective atomic number image according to some embodiments of the present disclosure;

FIG. 8B is a Bland-Altman diagram illustrating an accuracy of an effective atomic number value of a pixel of a target subject according to some embodiments of the present disclosure;

FIG. 9 is a block diagram illustrating an exemplary second processing device according to some embodiments of the present disclosure;

FIG. 10 is a flowchart illustrating an exemplary process for generating a target spectral image according to some embodiments of the present disclosure; and

FIG. 11 is a schematic diagram illustrating an exemplary process for generating a target spectral image according to some embodiments of the present disclosure.

### DETAILED DESCRIPTION

In order to more clearly illustrate the technical solutions of the embodiments of the present disclosure, the following briefly introduces the drawings that need to be used in the description of the embodiments. Obviously, the accompanying drawings in the following description are only some examples or embodiments of the present disclosure, for those skilled in the art, the present disclosure may also be applied to other similar scenarios according to these drawings without any creative effort. Unless obviously obtained from the context or the context illustrates otherwise, the same numeral in the drawings refers to the same structure or operation.

It will be understood that the term “system,” “engine,” “unit,” “module,” and/or “block” used herein are one method to distinguish different components, elements, parts, sections or assembly of different levels in ascending order. However, the terms may be displaced by another expression if they achieve the same purpose.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including” when used in this disclosure, specify the presence of stated features, integers, steps, operations, elements, and/or components, but do not preclude the presence or addition of one or more other features, integers, steps, operations, elements, components, and/or groups thereof.

The flowcharts used in the present disclosure illustrate operations that systems implement according to some embodiments in the present disclosure. Related descriptions are intended to facilitate a better understanding of methods and/or systems for medical imaging. It is to be expressly understood, the operations of the flowchart may be implemented not in order. Conversely, the operations may be implemented in an inverted order, or simultaneously. Moreover, one or more other operations may be added to the flowcharts. One or more operations may be removed from the flowcharts.

A photon-counting computed tomography device may bring a real material resolution to CT scanning. An operator may obtain various spectral images of a target subject with a certain accuracy based on actual viewing requirements. The operator may obtain a reasonable and required spectral image in a specific clinical scenario (e.g., a nature of a tumor, a rehabilitation progress of a patient, etc.) based on corresponding spectral intermediate data or a spectral intermediate data package, thereby reducing a volume or an amount of transmitted data that is used to generate a spectral image, achieving an effective data transmission between different processing devices, and satisfying various viewing requirements of the operator. However, a volume or an amount of the transmitted data and a quality of the spectral image may depend on an imaging system, a correction process of parameters related to a required spectral image, and a subsequent processing progress of data simultaneously.

The embodiments of the present disclosure provide a method and system for spectral imaging using a photon-counting computed tomography device. Scan data of a target subject may be obtained. The scan data may include at least one set of sub-scan data, and each of the at least one set of sub-scan data may correspond to an energy range (e.g., an energy bin) or an energy level. At least one intermediate image may be generated based on the least one set of sub-scan data by using an image reconstruction algorithm. Spectral intermediate data may be determined based on the at least one intermediate image. A target spectral image may be generated based on the spectral intermediate data, which is convenient for tracking a change of a condition of the target subject, thereby reducing transmitted data between different devices, generating spectral intermediate data matching with an imaging of a spectral image, and satisfying an actual viewing requirement of an operator.

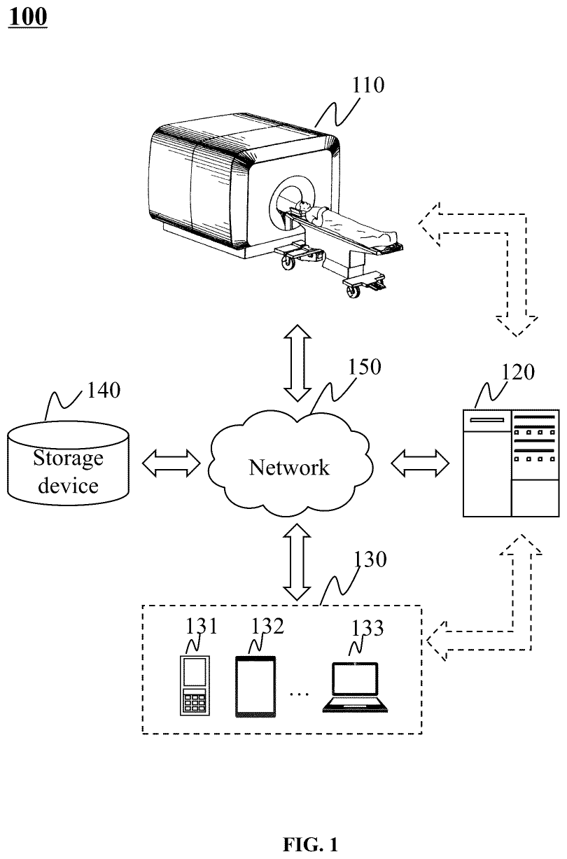

FIG. 1 is a schematic diagram illustrating an exemplary imaging system according to some embodiments of the present disclosure.

As illustrated in FIG. 1, an imaging system 100 may include a scanner 110, a processing device 120, one or more terminal devices 130, a storage device 140, and a network 150. The components of the imaging system 100 may be connected in one or more of various ways. Merely by way of example, as illustrated in FIG. 1, the scanner 110 may be connected to the processing device 120 through the network 150. As another example, the scanner 110 may be connected to the processing device 120 directly, which is as indicated by the bi-directional arrow in dotted lines linking the scanner 110 and the processing device 120. As a further example, the storage device 140 may be connected to the processing device 120 directly (not shown in FIG. 1) or through the network 150. As another further example, the one or more terminal devices 130 may be connected to the processing device 120 directly (as indicated by the bi-directional arrow in dotted lines linking the terminal device(s) 130 and the processing device 120) or through the network 150.

The scanner 110 may scan a target subject located within a detection region and generate scan data (e.g., an output of a detector) to obtain a medical image (e.g., an intermediate image, a target image, etc.) relating to the target subject. In some embodiments, the target subject may include a biological subject and/or a non-biological subject. For example, the target subject may include a specific portion of a body, such as head, chest, stomach, or the like, or any combination thereof. As another example, the target subject may be animate or inanimate, organic and/or inorganic substances of man-made composition.

In some embodiments, the scanner 110 may include a non-invasive biological imaging device for disease diagnosis or research purposes. For example, the scanner 110 may include a single-modality scanner and/or a multi-modality scanner. The single-modality scanner may include, for example, an ultrasonic scanner, an X-ray scanner, a Computed Tomography (CT) scanner, a Magnetic Resonance Imaging (MRI) scanner, an ultrasonic examination instrument, a Positron Emission Computed Tomography (PET) scanner, an optical coherence tomography (OCT) scanner, an ultrasound (US) scanner, an intravascular ultrasound (IVUS) scanner, a near infrared spectroscopy (NIRS) scanner, a far infrared (FIR) scanner, etc. The multi-modality scanner may include, for example, an X-ray imaging-MRI (X-ray-MRI) scanner, a PET-X-ray imaging (PET-X ray) scanner, a Single-Photon Emission Computed Tomography-X-ray imaging (SPECT-MRI) scanner, a PET-CT scanner, a Digital subtraction angiography-MRI (DSA-MRI) scanner, etc. The scanners mentioned above are merely for illustration purposes, which are not limited to the scope of the present disclosure. As illustrated in the present disclosure, the term “imaging modality” or “modality” broadly refers to an imaging method or technique for collecting, generating, processing, and/or analyzing imaging information of a target subject.

In some embodiments, the scanner 110 may include modules and/or components used to perform imaging and/or related analysis. For example, the scanner 110 may include a ray-generating device, an accessory device, and an imaging device. The ray-generating device may refer to a device configured to generate and control rays (e.g., X-rays). The accessory device may refer to a facility configured to satisfy requirements of clinical diagnosis and treatment. For example, the accessory device may include a mechanical device such as an examining table, a clinical table, a table with a draft tube, a photography table, various supports, a suspension device, a braking device, a grid, a keeping device, a shutter, etc. In some embodiments, the ray-generating device may be in various forms. For example, a digital imaging device may include a detector, a computer system, and image processing software, etc. Another imaging device may include a phosphor screen, a cassette, an image intensifier, a video TV, etc.

In some embodiments, data (e.g., an intermediate image, a target image of a target subject, etc.) acquired by the scanner 110 may be transmitted to the processing device 120 for further process (e.g., a dual-material decomposition and denoising operation, a weighting operation, a correction operation, etc.). Alternatively, data acquired by the scanner 110 may be transmitted to a terminal device (e.g., the terminal device 130) for display and/or a storage device (e.g., the storage device 140) for storage.

The processing device 120 may process data and/or information obtained from the scanner 110, the terminal device 130, the storage device 140, and/or other storage devices. For example, the processing device 120 may obtain scan data, the intermediate image(s), and the intermediate spectral data from the storage device 140, and generate a target image of the target subject based on the scan data, the intermediate image(s), and the intermediate spectral data. As another example, the processing device 120 may obtain a plurality of reference correction relationships of a reference subject (e.g., a phantom) from the scanner 110 and determine a plurality of correction parameters that are configured to generate the target image of the target subject.

In some embodiments, the processing device 120 may be a single server or a server group. The server group may be centralized or distributed. In some embodiments, the processing device 120 may be local to or remote from the imaging system 100. In some embodiments, the processing device 120 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the processing device 120 may be implemented on a computing device. In some embodiments, the processing device 120 may be implemented on a terminal (e.g., the terminal device 130). In some embodiments, the processing device 120 may be implemented on an imaging device (e.g., the scanner 110). For example, the processing device 120 may be integrated into the terminal device 130 and/or the scanner 110.

The terminal device 130 may be connected to the scanner 110 and/or the processing device 120 to input or output information and/or data. For example, a user may interact with the scanner 110 via the terminal device 130 to control one or more components (e.g., input patient information, select a parameter determination mode (e.g., automatic determination, manual input, or semi-automatic determination), adjust at least one of scanning parameter and/or processing parameter, etc.) of the scanner 110. As another example, the scanner 110 may transmit the medical image (e.g., a target image) and/or a spectral data packet to the terminal device 130 to generate and/or display the medical image.

In some embodiments, the terminal device 130 may include a mobile device 131, a tablet computer 132, a laptop computer 133, or the like, or any combination thereof. In some embodiments, the mobile device 131 may include a smart home device, a wearable device, a smart mobile device, a virtual reality device, an augmented reality device, a server workstation, or the like, or any combination thereof.

In some embodiments, one or more terminal devices 130 may remotely operate the scanner 110. In some embodiments, the terminal device 130 may operate the scanner 110 via a wireless connection. In some embodiments, one or more terminal devices 130 may be part of the processing device 120. In some embodiments, the terminal device 130 may be omitted.

The storage device 140 may store data and/or instructions. In some embodiments, the storage device 140 may store data obtained from the terminal device 130 and/or the processing device 120. For example, the storage device 140 may store a plurality of energy levels, the intermediate images, the spectral intermediate data, the target spectral image, etc. In some embodiments, the storage device 140 may store data and/or instructions that the processing device 120 may execute or use to perform exemplary methods described in the present disclosure.

In some embodiments, the storage device 140 may include a mass storage device, a removable storage device, a volatile read-and-write memory, a read-only memory (ROM), or the like, or any combination thereof. Exemplary mass storage devices may include a magnetic disk, an optical disk, a solid-state drive, etc. Exemplary removable storage devices may include a flash drive, a floppy disk, an optical disk, a memory card, a zip disk, a magnetic tape, etc. Exemplary volatile read-and-write memory may include a random-access memory (RAM). In some embodiments, the storage device 140 may be part of the processing device 120.

The network 150 may include any suitable network that can facilitate the exchange of information and/or data for the imaging system 100. In some embodiments, one or more components of the imaging system 100 (e.g., the scanner 110, one or more terminal devices 130, the processing device 120, or the storage device 140) may communicate information and/or data with one or more other components of the imaging system 100 via the network 150.

In some embodiments, the network 150 may be any type of wired or wireless network, or a combination thereof. The network 150 may be and/or include a public network (e.g., the Internet), a private network (e.g., a local area network (LAN), a wide area network (WAN)), etc.), a wired network (e.g., an Ethernet network), a wireless network (e.g., an 802.11 network, a Wi-Fi network), a cellular network (e.g., a Long Term Evolution (LTE) network), a frame relay network, a virtual private network (“VPN”), a satellite network, a telephone network, routers, hubs, switches, server computers, and/or any combination thereof. In some embodiments, the network 120 may include one or more network access points.

It should be noted that the above description of the imaging system 100 is intended to be illustrative, and not to limit the scope of the present disclosure. Many alternatives, modifications, and variations will be apparent to those skilled in the art. However, these alternatives, modifications, and variations may not depart from the scope of the present disclosure. For example, the scanner 110, the processing device 120, and the terminal device 130 may share the storage device 140, or have their own storage device.

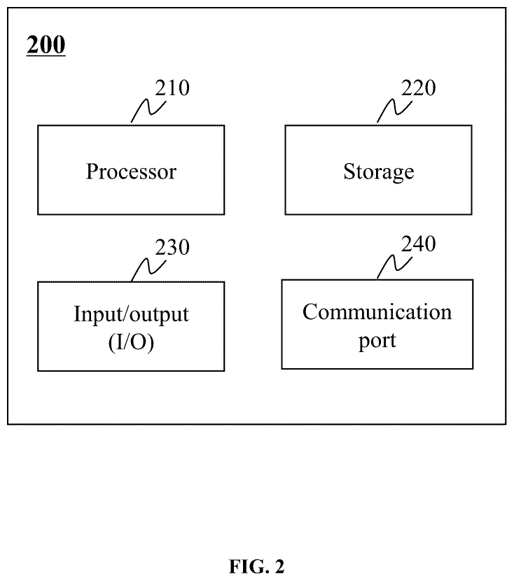

FIG. 2 is a schematic diagram illustrating exemplary hardware and/or software components of an exemplary computing device according to some embodiments of the present disclosure.

As shown in FIG. 2, in some embodiments, the computing device 200 may include a processor 210, a memory 220, an input/output (I/O) 230, and a communication port 240.

The processor 210 may execute computer instructions (e.g., program code) and perform functions of the processing device 120 according to the method(s) described herein. The computer instructions may include, for example, routines, programs, objects, components, data structures, procedures, modules, and functions, which perform particular functions described herein. For example, the processor 210 may process data of the scanner 110, the terminal device 130, the storage device 140, and/or any other component in the imaging system 100. In some embodiments, the processor 210 may include at least one hardware processor, such as a microcontroller, a microprocessor, a reduced instruction set computer (RISC), an application specific integrated circuit (ASIC), an application specific instruction set processor (ASIP), a central processing unit (CPU), a graphics processing unit (GPU), a physical processing unit (PPU), microcontroller unit, a digital signal processor (DSP), a field programmable gate array (FPGA), a high-order RISC Machine (ARM), a programmable logic device (PLD), any circuit or processor or similar capable of performing at least one function, or any combination thereof.

Merely for illustration, only one processor is described in the computing device 200. However, it should be noted that the computing device 200 in the present disclosure may also include multiple processors, thus operations and/or method steps that are performed by one processor as described in the present disclosure may also be jointly or separately performed by the multiple processors. For example, if in the present disclosure the processor of the computing device 200 executes both operations A and B, it should be understood that operation A and operation B may also be performed by two or more different processors jointly or separately in the computing device 200 (e.g., a first processor executes operation A and a second processor executes operation B, or the first and second processors jointly execute operations A and B).

The memory 220 may store data/information obtained from the scanner 110, the terminal device 130, the storage device 140, and/or any other component in the imaging system 100. In some embodiments, the memory 220 may include a mass storage, a removable storage, a volatile read-write memory, a read-only memory (ROM), or any combination thereof. In some embodiments, the memory 220 may store at least one program and/or instruction for executing the exemplary manner described in the present disclosure.

The input/output (I/O) 230 may be used to input and/or output signals, data, information, etc. In some embodiments, the input/output (I/O) 230 may enable the user to interact with processing device 120. In some embodiments, the input/output (I/O) 230 may include an input device and an output device. An exemplary input device may include a keyboard, a mouse, a touch screen, a microphone, or any combination thereof. The exemplary output device may include a display device, a speaker, a printer, a projector, or any combination thereof. An exemplary display device may include a liquid crystal display (LCD), a light emitting diode (LED)-based display, a flat panel display, a curved surface display, a television device, a cathode ray tube, or any combination thereof.

The communication port 240 may be connected with a network (e.g., the network 150) to facilitate data communication. The communication port 240 may establish a connection between the processing device 120 and the scanner 110, the terminal device 130, and/or the storage device 140. The connection may include a wired connection and a wireless connection. The wired connection may include, for example, cable, optical cable, telephone line, or any combination thereof. The wireless connection may include, for example, Bluetooth link, Wi-Fi™ link, WiMax™ link, WLAN link, ZigBee link, mobile network link (e.g., 3G, 4G, 5G), or any combination thereof. In some embodiments, the communication port 240 may be and/or include a standardized communication port, such as RS232, RS485, etc. In some embodiments, the communication port 240 may be a specially designed communication port. For example, the communication port 240 may be designed according to a digital imaging and medical communication (DICOM) protocol.

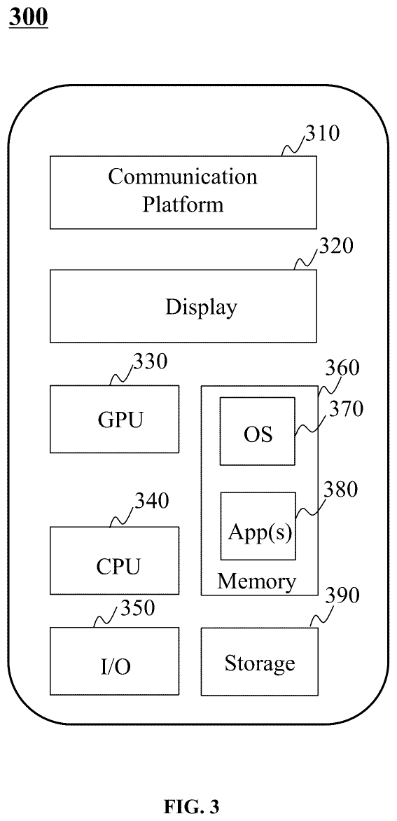

FIG. 3 is a schematic diagram illustrating exemplary hardware and/or software components of a mobile device 300 according to some embodiments of the present disclosure.

In some embodiments, one or more components of the imaging system 100 may be implemented on one or more components of the mobile device 300. Merely by way of example, the terminal 130 may be implemented on one or more components of the mobile device 300.

As illustrated in FIG. 3, the mobile device 300 may include a communication platform 310, a display 320, a graphics processing unit (GPU) 330, a central processing unit (CPU) 340, an I/O 350, a memory 360, and a storage 390. In some embodiments, any other suitable component, including but not limited to a system bus or a controller (not shown), may also be included in the mobile device 300. In some embodiments, a mobile operating system 370 (e.g., iOS™, Android™, Windows Phone™, etc.) and one or more applications 380 may be loaded into the memory 360 from the storage 390 in order to be executed by the CPU 340. The applications 380 may include a browser or any other suitable mobile apps for receiving and rendering information relating to the imaging system 100. User interactions with the information stream may be achieved via the I/O 350 and provided to the processing device 120 and/or other components of the imaging system 100 via the network 150.

To implement various modules, units, and their functionalities described in the present disclosure, computer hardware platforms may be used as the hardware platform(s) for one or more of the elements described herein. A computer with user interface elements may be used to implement a personal computer (PC) or any other type of workstation or terminal device. A computer may also act as a server if appropriately programmed.

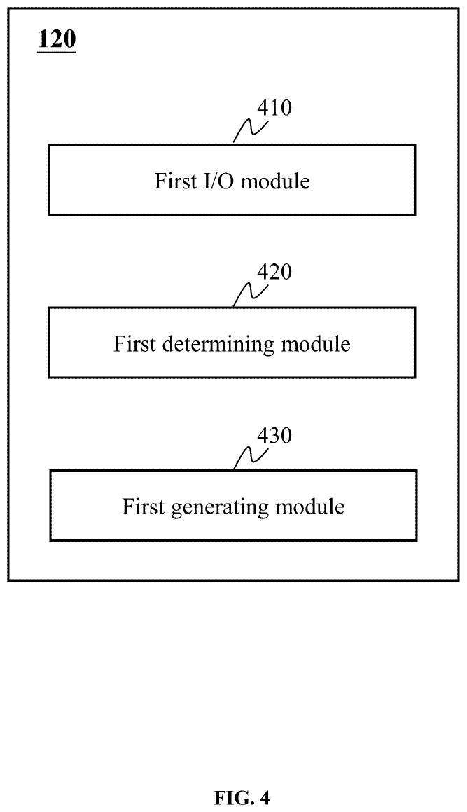

FIG. 4 is a block diagram illustrating an exemplary first processing device according to some embodiments of the present disclosure.

As illustrated in FIG. 4, in some embodiments, the first processing device 400 may include a first Input/Output (I/O) module 410, a first determining module 420, and a first generating module 430. In some embodiments, the first processing device 400 may be integrated into the processing device 120 or the computing device 200.

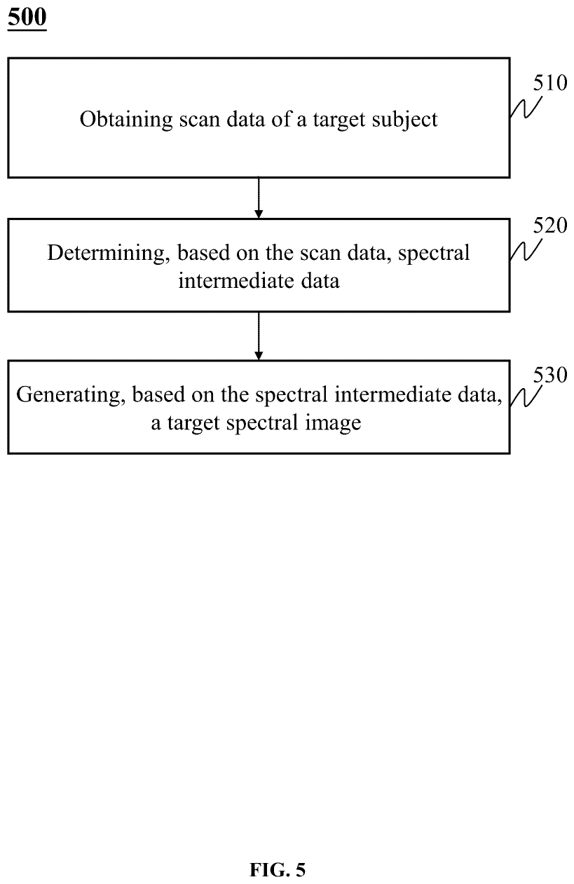

The first Input/Output (I/O) module 410 may be configured to obtain scan data of a target subject. In some embodiments, the first Input/Output (I/O) module 410 may obtain the scan data of the target subject from the storage device (e.g., the storage device 140). In some embodiments, the first Input/Output (I/O) module 410 may obtain the scan data of the target subject from the terminal device (e.g., the terminal device 130) or the imaging device (e.g., the scanner 110). In some embodiments, the first Input/Output (I/O) module 410 may obtain the scan data of the target subject from the medical system. The scan data may include at least one set of sub-scan data, and each of the at least one set of sub-scan data may correspond to an energy range (e.g., an energy bin) or an energy level (e.g., an energy level corresponding to a low voltage or a high voltage). More descriptions for obtaining scan data of a target subject may be found elsewhere in the present disclosure (e.g., operation 510 in FIG. 5 and descriptions thereof).

The first determining module 420 may be configured to determine, based on the at least one set of sub-scan data, spectral intermediate data. In some embodiments, the first determining module 420 may determine the spectral intermediate data by performing a domain decomposition using a projection approach on the scan data or the set of sub-scan data to obtain domain decomposition data of projection data, and generate the spectral intermediate data by performing an image reconstruction algorithm on the domain decomposition data of the projection data. In some embodiments, the first determining module 420 may determine the spectral intermediate data by performing the domain decomposition using the projection approach on the scan data or the set of sub-scan data to generate the decomposition data of the projection data and performing the image reconstruction algorithm on the decomposition data of the projection data iteratively. In some embodiments, the first determining module 420 may determine the spectral intermediate data based on at least one intermediate image. The at least one intermediate image may be generated based on the at least one set of sub-scan data by using an image reconstruction algorithm. More descriptions for determining spectral intermediate data based on the at least one set of sub-scan data may be found elsewhere in the present disclosure (e.g., operation 520 in FIG. 5 and descriptions thereof).

The first generating module 430 may be configured to generate, based on the spectral intermediate data, a target spectral image. In some embodiments, the first generating module 430 may generate the target spectral image based on at least one target imaging parameter matching with the type of the target spectral image. In some embodiments, in response to a select request of the type of the target spectral image, the first generating module 430 may determine the at least one target imaging parameter matching with the type of the target spectral image, and generate the target spectral image corresponding to the type of the target spectral image based on the at least one target imaging parameter and the spectral intermediate data. In some embodiments, the first generating module 430 may obtain a target noise level and generate the target spectral image based on the type of the target spectral image and the spectral intermediate data corresponding to the target noise level. More descriptions for generating a target spectral image based on the spectral intermediate data may be found elsewhere in the present disclosure (e.g., operation 530 in FIG. 5 and descriptions thereof).

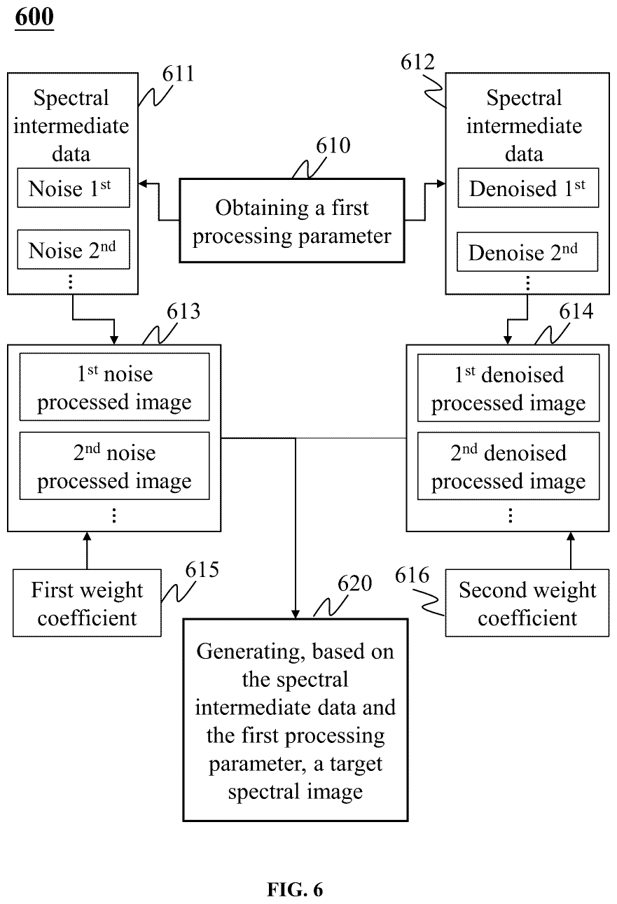

More details about the first I/O module 410, the first determining module 420, and the first generating module 430 may be found in FIG. 6 and the related descriptions thereof, which is not limited herein.

It should be noted that the above description of the modules and the first processing device 400 is intended to be illustrative, and not to limit the scope of the present disclosure. It should be understood that, for persons having ordinary skills in the art, each module may be combined arbitrarily, or form a subsystem to be connected with other modules under the teachings of the present disclosure. However, those variations and modifications do not depart from the scope of the present disclosure.

FIG. 5 is a flowchart illustrating an exemplary process for spectral imaging according to some embodiments of the present disclosure.

In some embodiments, a spectral imaging method 500 may be executed by the imaging system 100 (e.g., the processing device 120) or the computing device 200 (e.g., the processor 210). For example, the spectral imaging method 300 may be implemented as a set of instructions or an application stored in a storage device (e.g., the storage device 140). The processing device 120 may execute the set of instructions or the application and may accordingly be directed to perform the imaging method 500.

In 510, scan data of a target subject may be obtained. In some embodiments, operation 510 may be performed by the processing device 120 or the first I/O module 410.

A target subject may be a subject to be scanned. In some embodiments, the target subject may include a patient to be scanned or a portion to be scanned of the patient.

The scan data of the target subject may refer to related data determined by scanning the target subject. The scan data may be acquired by a detector of the scanner 110. In some embodiments, the detector of the scanner 110 may include a detector capable of distinguishing a plurality of energy ranges, and the scan data may be determined or obtained by counting photons in at least one energy range. In some embodiments, an energy range may include an energy bin. For example, the scan data may include scan data of a full energy bin (i.e., full bin data) and scan data of a plurality of energy bins (i.e., single bin data of an energy bin). In some embodiments, the scan data may include at least one set of sub-scan data, and each of the at least one set of sub-scan data may correspond to an energy range (e.g., an energy bin).

In some embodiments, the detector of the scanner 110 may include a detector capable of responding to X-rays with different energy levels (e.g., low energy X-rays or high energy X-rays) generated under a plurality of tube voltages (e.g., a low voltage or a high voltage), and the scan data may be determined or obtained based on different energy levels through the detector. For example, the scan data may be obtained based on a low energy level corresponding to a low voltage (e.g., 80 kVp) and/or a high energy level corresponding to a high voltage (e.g., 140 kVp). In some embodiments, the scan data may include at least one set of sub-scan data, and each of the at least one set of sub-scan data may correspond to an energy level.

In some embodiments, the processing device (e.g., the processing device 120 and the processor 210) may obtain the scan data of the target subject from the storage device (e.g., the storage device 140). In some embodiments, the processing device may obtain the scan data of the target subject from the terminal device (e.g., the terminal device 130) or the imaging device (e.g., the scanner 110). In some embodiments, the processing device may obtain the scan data of the target subject from a medical system.

In 520, spectral intermediate data may be determined based on the scan data. In some embodiments, the operation 520 may be performed by the processing device 120 or the first determining module 420.

The spectral intermediate data may refer to data or at least one spectral image that represents spectral features (e.g., a power spectral density, an energy spectral density, a frequency characteristic, etc.) of an intermediate image. For example, the spectral intermediate data may be determined or extracted from an intermediate image. In some embodiments, the spectral intermediate data may include at least one of noise spectral intermediate data, denoised spectral intermediate data, or the like, or a combination thereof. More details regarding the spectral intermediate data may be found in FIG. 6 and the related descriptions thereof, which is not limited herein.

In some embodiments, the processing device (e.g., the processing device 120 and the processor 210) may determine the spectral intermediate data by performing a domain decomposition using a projection approach on the scan data or the set of sub-scan data to obtain domain decomposition data of projection data, and generate the spectral intermediate data by performing an image reconstruction algorithm on the domain decomposition data of the projection data.

In some embodiments, the processing device (e.g., the processing device 120 and the processor 210) may determine the spectral intermediate data by performing the domain decomposition using the projection approach on the scan data or the set of sub-scan data to generate the decomposition data of the projection data and performing the image reconstruction algorithm on the decomposition data of the projection data iteratively.

In some embodiments, the spectral intermediate data may be determined based on at least one intermediate image. The at least one intermediate image may be generated based on the at least one set of sub-scan data by using the image reconstruction algorithm.

An intermediate image may refer to a reconstructed image of the scan data or a reconstructed image of a set of sub-scan data. For example, the intermediate image may include a CT image, an MRI image, or the like. In some embodiments, the intermediate image may include a full bin image reconstructed based on the scan data or the set of sub-scan data of a full energy bin. For example, if a voltage corresponding to a maximum energy level is 120 kVp, the full energy bin is determined based on a voltage range of 0˜120 kVp, and the intermediate image may include a full bin image corresponding to signals of 0˜120 kVp. In some embodiments, the intermediate image may include at least one single bin image reconstructed based on at least one set of sub-scan data of a corresponding energy bin. For example, if a first energy bin is determined based on a first voltage sub-range of 0˜10 kVp, and a second energy bin is determined based on a second voltage sub-range of 10˜20 kVp, the intermediate image may include a first single bin image corresponding to signals of 0˜10 kVp and a second single bin image corresponding to signals of 10˜20 kVp. That is, the first single bin image of the intermediate image is generated based on the sub-scan data of the first energy bin (e.g., an energy bin determined based on a voltage sub-range of 0˜10 kVp), and the second single bin image of the intermediate image is generated based on the sub-scan data of the second energy bin (e.g., an energy bin determined based on a voltage sub-range of 10˜20 kVp).

In some embodiments, the processing device (e.g., the processing device 120 and the processor 210) may generate the intermediate image (e.g., the first single bin image, the second single bin image, etc.) based on the at least one set of sub-scan data by using the image reconstruction algorithm. The image reconstruction algorithm may include a parallel beam reconstruction algorithm, a direct back projection algorithm, a filtered back projection algorithm, an iterative reconstruction algorithm, or the like.

In some embodiments of the present disclosure, the spectral intermediate data may be extracted from the at least one intermediate image, so that a transmitted data volume may be greatly reduced, thereby improving a processing efficiency of the system 100 for spectral imaging.

In some embodiments, the processing device (e.g., the processing device 120 and the processor 210) may determine the spectral intermediate data by performing a dual-material decomposition and denoising operation on the at least one intermediate image.

In 530, a target spectral image may be generated based on the spectral intermediate data. In some embodiments, operation 530 may be performed by the processing device 120 or the first generating module 430.

The target spectral image may refer to an image corresponding to a target spectral imaging function. In some embodiments, the target spectral imaging function may refer to an imaging function that satisfies an actual viewing requirement of the user. For example, the spectral imaging function may include but is not limited to a dual-base material pair spectral imaging function, a virtual monoenergetic spectral imaging function, a virtual non-contrast spectral imaging function, an electron density spectral imaging function, an effective atomic number spectral imaging function, or the like. In some embodiments, the target spectral imaging function may refer to an imaging function selected by the user. For example, a spectral imaging function may be displayed on an interface of the processing device (e.g., the processing device 120, the computing device 200, and the first processing device 400) or the terminal device (e.g., the terminal device 130, the mobile device 300, and the second processing device 410), the user may merely select one spectral imaging function as the target spectral imaging function, or the user may select a plurality of spectral imaging functions as target spectral imaging functions.

In some embodiments, a type of the target spectral image may include at least one of a dual-base material pair image, a virtual monoenergetic image (VMI), a virtual non-contrast image, an electron density image, an effective atomic number image, or the like.

In some embodiments of the present disclosure, the various types of target spectral images may be generated based on the corresponding spectral imaging functions, so that various user requirements may be satisfied, thereby improving user experience and expanding an application scenario of the system 100 for spectral imaging.

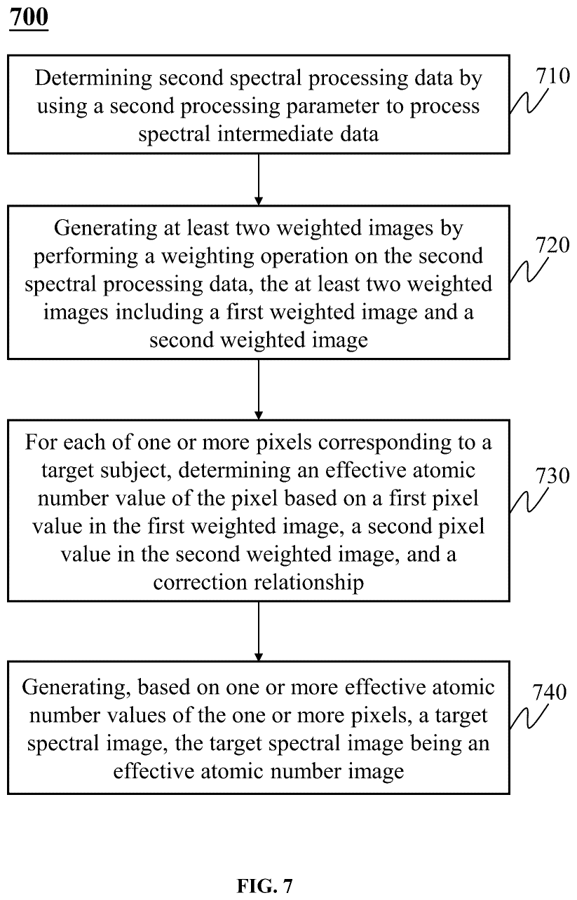

In some embodiments, the processing device (e.g., the processing device 120 and the processor 210) may generate the target spectral image based on at least one target imaging parameter matching with the type of the target spectral image. An imaging parameter may refer to a parameter used for image processing to generate an image satisfying a first preset condition. For example, the imaging parameter may include a processing parameter (e.g., an image transformation parameter), a noise parameter, a denoised parameter, or the like, or a combination thereof, and the first preset condition may include a target noise level of the target spectral image, a type of the target spectral image, or the like, or a combination thereof. More details of the imaging parameter may be found in FIGS. 6 and 7, and the related descriptions thereof, which is not limited herein.

In some embodiments, in response to a select request of the type of the target spectral image, the processing device may determine the at least one target imaging parameter matching with the type of the target spectral image, and generate the target spectral image corresponding to the type of the target spectral image based on the at least one target imaging parameter and the spectral intermediate data. The select request of the type of the target spectral image may be generated by a voice, button, touch control, or the like, or a combination thereof, input by the user.

In some embodiments, the processing device (e.g., the processing device 120 and the processor 210) may establish a first correlation between a type of the target spectral image and at least one imaging parameter, and determine the at least one target imaging parameter matching with the type of the target spectral image based on the first correlation. For example, the first correlation may be represented as {(type A—an imaging parameter a), (type B—an imaging parameter b), (type C—an imaging parameter c)}, and in response to a determination that the type of the target spectral image is type A, the processing device may generate the target spectral image based on the imaging parameter a.

In some embodiments, the first correlation may be represented in various manners. For example, the first correlation may be represented as a table, and the target imaging parameter(s) may be determined by a field matching. As another example, the first correlation may be represented as a function related to the type of the target spectral image, and the target imaging parameter(s) may be determined based on the function. As further another example, the first correlation may be represented as a parameter determination model, and the target imaging parameter(s) may be determined based on an output of the parameter determination model. In some embodiments, the parameter determination model may include a machine learning model. For example, the parameter determination model may include a supervised learning model, an unsupervised learning model, a reinforcement learning model, a neural network model, or the like. More details of the first correlation may be found in FIG. 6 and the related descriptions thereof, which is not limited herein.

In some embodiments, the processing device (e.g., the processing device 120 and the processor 210) may obtain a target noise level and generate the target spectral image based on the type of the target spectral image and the spectral intermediate data corresponding to the target noise level. In some embodiments, the target noise level may be determined or selected by the user. For example, a noise level for the user selection (i.e., a candidate noise level) may be within a range of 0˜9, the greater the noise level is, the greater the noise is, and the target noise level may be determined or selected from the range of 0˜9.

In some embodiments, the processing device (e.g., the processing device 120 and the processor 210) may obtain the target noise level (e.g., a commonly used noise level) from the storage device (e.g., the storage device 140) and generate the target spectral image corresponding to the target noise level. In some embodiments, the processing device may obtain the target noise level (e.g., a noise level input by the user) from the terminal device (e.g., the terminal device 130) and generate the target spectral image corresponding to the target noise level.

More details about generating the target spectral image based on the spectral intermediate data may be found in FIGS. 5, 6, and 7, and the related descriptions thereof, which is not limited herein.

In some embodiments, a volume or an amount of the spectral intermediate data may be determined based on the type of the target spectral image. For example, a volume or an amount of the noise spectral intermediate data, or a volume or an amount of the denoised spectral intermediate data is related to the type of the target spectral image. More details may be found in FIG. 6 and the related descriptions thereof, which is not limited herein.

In some embodiments of the present disclosure, the volume or the amount of the spectral intermediate data may be adapted to the type of the target spectral image generated based on the actual viewing needs of the user, so that computing resources of the system 100 for spectral imaging may be greatly reduced while satisfying the user requirements.

In some embodiments of the present disclosure, the target spectral image may be generated based on the spectral intermediate data, so that the target spectral image may satisfy a required noise level (also referred to as the target noise level) and a viewing needs (e.g., the type of the target spectral image) of the user, and an efficient transmission of data used to generate the target spectral image may be achieved.

It should be noted that the above description regarding process 500 is merely provided for the purposes of illustration, and not intended to limit the scope of the present disclosure. For those skilled in the art, various modifications and variations may be made for the process 500 under the guidance of the present disclosure. However, these modifications and variations do not depart from the scope of the present disclosure.

FIG. 6 is a flowchart illustrating an exemplary process for generating a target spectral image according to some embodiments of the present disclosure.

In some embodiments, a process 600 may be executed by the imaging system 100 (e.g., the processing device 120), the computing device 200 (e.g., the processor 210), or the first processing device 400. For example, the process 600 may be implemented as a set of instructions or an application stored in a storage device (e.g., the storage device 140). The processing device 120 may execute the set of instructions or the application and may accordingly be directed to perform the process 600.

In 610, a first processing parameter may be obtained. In some embodiments, operation 610 may be performed by the processing device 120 or the first I/O module 410.

A processing parameter may refer to a parameter used during the processing of an image. In some embodiments, the first processing parameter may include the imaging parameter. More details of the imaging parameter may be found in FIG. 5 and the related descriptions thereof.

In some embodiments, the first processing parameter may be related to the target noise level. More details of the target noise level may be found in FIG. 5 and the related descriptions thereof, which is not limited herein.

In some embodiments of the present disclosure, the spectral intermediate data may be processed by the first processing parameter, so that the corresponding spectral processing data may be adapted to the type of the target spectral image, thereby satisfying the viewing requirements of the user.

In some embodiments, the first processing parameter may be determined based on the type of the target spectral image. For example, the type of the target spectral image may include at least one of the dual-base material pair image, the virtual non-contrast image, the electron density image, or the like.

In some embodiments, the first processing parameter may include a transformation matrix. The transformation matrix may include at least one transformation factor. The at least one transformation factor may be related to the type of the target spectral image. In some embodiments, the at least one transformation factor may be a real number.

In some embodiments, a count of the at least one transformation factor may be determined based on the volume or the amount of the spectral intermediate data. Merely by way of example, in response to a determination that the spectral intermediate data includes the noise spectral intermediate data and/or the denoised spectral intermediate data, if the noise spectral intermediate data or the denoised spectral intermediate data corresponds to two intermediate images (e.g., two intermediate CT images), the noise spectral intermediate data or the denoised spectral intermediate data may be represented as a matrix M with one row and two columns such as [CT₁, CT₂], and the first processing parameter may be a matrix N with two rows and two columns such as

$$[ \begin{matrix}{F}_{11} & {F}_{12} \\ {F}_{21} & {F}_{22}\end{matrix} ] ,$$

wherein F₁₁, F₁₂, F₂₁, and F₂₂ are the transformation factors. The two intermediate images (e.g., two intermediate CT images) may be transformed or processed by multiplying the matrix M and the matrix N, and the two transformed or processed intermediate images may be represented as a matrix M′ with one row and two columns such as [CT₁′, CT₂′]. More details may be found in operation 620 and the related descriptions thereof, which is not limited herein.

In some embodiments of the present disclosure, the first processing parameter may be the transformation matrix, so that the spectral intermediate data may be transformed to adapt to the type of the target spectral image.

In some embodiments, the processing device (e.g., the processing device 120 and the processor 210) may obtain the first processing parameter from the storage device (e.g., the storage device 140). In some embodiments, the processing device may obtain the first processing parameter from the terminal device (e.g., the terminal device 130) or the imaging device (e.g., the scanner 110). In some embodiments, the processing device may obtain the first processing parameter from the medical system.

In 620, the target spectral image may be generated based on the spectral intermediate data and the first processing parameter. In some embodiments, operation 620 may be performed by the processing device 120 or the first generating module 430.

In some embodiments, the processing device (e.g., the processing device 120 and the processor 210) may determine or select the first processing parameter based on the target noise level, and generate the target spectral image based on the first processing parameter and the spectral intermediate data.

In some embodiments, a plurality of candidate noise levels for selection may be displayed on an interface of the processing device (e.g., the processing device 120, the computing device 200, and the first processing device 400) or the terminal device (e.g., the terminal device 130, the mobile device 300, and the second processing device 410), and the user may select a target noise level from the plurality of candidate noise levels by the voice, button, touch control, or the like.

In some embodiments, the processing device (e.g., the processing device 120 and the processor 210) may determine first spectral processing data by using the first processing parameter to process the spectral intermediate data, and generate the target spectral image by performing a weighting operation on the first spectral processing data.

In some embodiments, the first spectral processing data may include at least one of noise spectral processing data and denoised spectral processing data.

In some embodiments, the spectral intermediate data may include the noise spectral intermediate data (e.g., noise spectral intermediate data 611), and the first spectral processing data may be noise spectral processing data generated by using the first processing parameter to process the noise spectral intermediate data (e.g., noise spectral intermediate data 611). In some embodiments, the noise spectral intermediate data may be a plurality of noise spectral intermediate images, and the first spectral processing data may be a plurality of noise processed images (e.g., 1^{st} and 2^{nd} noise processed images 613) generated by using the first processing parameter to process the plurality of noise spectral intermediate images, respectively. Merely by way of example, the plurality of noise spectral intermediate images may be represented as a matrix P with one row and n columns, where n denotes a positive integer that is greater than or equal to two. That is, the matrix P may be denoted as P=[I₁, I₂ . . . Iₙ]. The first processing parameter may be a matrix Q with n rows and n columns, where n denotes a positive integer that is greater than or equal to two. That is, the matrix Q may be represented as a matrix P with one row and n columns, where n denotes a positive integer that is greater than or equal to two denoted as

$$Q = [ \begin{matrix}{F}_{11} & {F}_{12} & … & {F}_{1 n} \\ {F}_{21} & {F}_{22} & … & {F}_{2 n} \\ ⋮ & ⋮ & & ⋮ \\ {F}_{n 1} & {F}_{n 2} & … & {F}_{nn}\end{matrix} ] .$$

The plurality of noise processed images may be represented as a matrix P′ with one row and n columns, which is determined by multiplying the matrix P and the matrix Q. That is, the matrix P′ may be represented as [I₁′ I₂′ . . . Iₙ′], which is determined by:

$$[ {I}_{1} {I}_{2} … {I}_{n} ] \times [ \begin{matrix}{F}_{11} & {F}_{12} & … & {F}_{1 n} \\ {F}_{21} & {F}_{22} & … & {F}_{2 n} \\ ⋮ & ⋮ & & ⋮ \\ {F}_{n 1} & {F}_{n 2} & … & {F}_{nn}\end{matrix} ] = [ {I}_{1}^{′} {I}_{2}^{′} … {I}_{n}^{′} ] ,$$

wherein Iₙ′=(Iₙ·F₁ₙ+Iₙ·F₂ₙ+ . . . +Iₙ·Fₙₙ).

In some embodiments, the processing device may assign a plurality of first weight coefficients 615 to the plurality of noise processed images (e.g., 1^{st} and 2^{nd} noise processed images 613), respectively, and generate the target spectral image by performing the weighting operation on the plurality of noise processed images (e.g., 1^{st} and 2^{nd} noise processed images 613) based on the plurality of first weight coefficients 615.

In some embodiments, the spectral intermediate data may include the denoised spectral intermediate data (e.g., denoised spectral intermediate data 612), and the first spectral processing data may be denoised spectral processing data generated by using the first processing parameter to process the denoised spectral intermediate data. In some embodiments, the denoised spectral intermediate data may be a plurality of denoised spectral intermediate images, and the first spectral processing data may be a plurality of denoised processed images (e.g., 1^{st} and 2^{nd} denoised processed images 614) generated by using the first processing parameter to process the plurality of denoised spectral intermediate images, respectively. In some embodiments, the generation of the plurality of denoised processed images (e.g., 1^{st} and 2^{nd} denoised processed images 614) may be similar to the generation of the plurality of noise processed images (e.g., 1^{st} and 2^{nd} noise processed images 613), which is not repeated herein.

In some embodiments, the processing device may assign a plurality of second weight coefficients 616 to the plurality of denoised processed images (e.g., 1^{st} and 2^{nd} denoised processed images 614), respectively, and generate the target spectral image by performing the weighting operation on the plurality of denoised processed images (e.g., 1^{st} and 2^{nd} denoised processed images 614) based on the plurality of second weight coefficients 616.

In some embodiments, the spectral intermediate data may include the noise spectral intermediate data (e.g., the noise spectral intermediate data 611) and the denoised spectral intermediate data (e.g., the denoised spectral intermediate data 612), and the first spectral processing data may include the noise spectral processing data and the denoised spectral processing data generated by using the first processing parameter to process the noise spectral intermediate data and the denoised spectral intermediate data, respectively. In some embodiments, the noise spectral intermediate data may be at least one noise spectral intermediate image, the denoised spectral intermediate data may be at least one denoised spectral intermediate image, and the first spectral processing data may include at least one noise processed image (e.g., 1^{st} and 2nd noise processed images 613) and at least one denoised processed image (e.g., 1^{st} and 2^{nd} denoised processed images 614) generated by using the first processing parameter to process the at least one noise spectral intermediate image and the at least one denoised spectral intermediate image, respectively.

In some embodiments, the processing device may assign at least one first weight coefficient 615 to the at least one noise processed image (e.g., 1^{st} and 2nd noise processed images 613) and assign at least one second weight coefficient 616 to the at least one denoised processed image (e.g., 1^{st} and 2^{nd} denoised processed images 614), respectively, and generate the target spectral image by performing the weighting operation on the at least one noise processed image (e.g., 1^{st} and 2nd noise processed images 613) and the at least one denoised processed image (e.g., 1^{st} and 2^{nd} denoised processed images 614) based on the at least one first weight coefficient 615 and the at least one second weight coefficient 616, respectively.

In some embodiments of the present disclosure, the first spectral processing data may include at least one of the noise spectral processing data and the denoised spectral processing data generated by using the first processing parameter to process the noise spectral intermediate data or the denoised spectral intermediate data, so that the first spectral processing data may satisfy a required noise level (also referred to as the target noise level) of the user.

In some embodiments, the spectral intermediate data (e.g., the plurality of noise spectral intermediate images and the plurality of denoised spectral intermediate images) may correspond to a plurality of noise levels, and the plurality of first weight coefficients or the plurality of second weight coefficients may be related to at least one of the noise level and the type of the target spectral image. More details of the noise level and the type of the target spectral image may be found in FIG. 5 and the related descriptions thereof, which is not repeated herein.

In some embodiments, the processing device (e.g., the processing device 120 and the processor 210) may establish a second correlation between the noise level and the plurality of first weight coefficients 615, and assign the plurality of first weight coefficients 615 matching with the target noise level based on the second correlation.

In some embodiments, the second correlation may be represented in various manners. For example, the second correlation may be represented as a table, and the plurality of first weight coefficients may be determined by a field matching. As another example, the second correlation may be represented as a function related to the target noise level, and the plurality of first weight coefficients may be determined based on the function. As further another example, the second correlation may be represented as the parameter determination model, and the plurality of first weight coefficients may be determined based on an output of the parameter determination model. More details of the parameter determination model may be found in FIG. 5 and the related descriptions thereof, which is not repeated herein.

In some embodiments, the processing device (e.g., the processing device 120 and the processor 210) may establish a third correlation between the noise level and the plurality of second weight coefficients 616, and assign the plurality of second weight coefficients 616 matching with the target noise level based on the third correlation. In some embodiments, the representation of the third correlation may be similar to the second correlation, which is not repeated herein.

In some embodiments, the first weight coefficient(s) 615 and the second weight coefficient(s) 616 may be set according to experience. In some embodiments, the first weight coefficient(s) 615 may be equal to the second weight coefficient(s) 616. For example, the first weight coefficient(s) 615 may be equal to the second weight coefficient(s) 616 may be equal to 0.5. In some embodiments, the first weight coefficient(s) 615 may be not equal to the second weight coefficient(s) 616. For example, the first weight coefficient(s) 615 may be equal to 0.4, and the second weight coefficient(s) 616 may be equal to 0.6.

In some embodiments, the first weight coefficient(s) 615 and the second weight coefficient(s) 616 may be matched with the type of the target spectral image. The processing device may establish a fourth correlation between a weight coefficient (e.g., the first weight coefficient 615 and the second weight coefficient 616) and the type of the target spectral image, and determine the first weight coefficient(s) 615 and the second weight coefficient(s) 616 that are matched with the type of the target spectral image based on the fourth correlation. In some embodiments, the determination of the fourth correlation may be similar to the first correlation, the second correlation, or the third correlation, which is not repeated herein.

In some embodiments, the first weight coefficient(s) 615 and the second weight coefficient(s) 616 may be determined based on the noise level and the type of the target spectral image. For example, the processing device may establish a fifth correlation among a weight coefficient (e.g., the first weight coefficient 615 and the second weight coefficient 616), the type of the target spectral image, and the noise level, and determine the first weight coefficient(s) 615 and the second weight coefficient(s) 616 that are matched with the type of the target spectral image and the noise level based on the fifth correlation. In some embodiments, the determination of the fifth correlation may be similar to the first correlation, the second correlation, or the third correlation, which is not repeated herein.

In some embodiments, the fifth correlation may be determined based on actual needs. The first weight coefficient(s) 615 and the second weight coefficient(s) 616 may be determined based on different types of the target spectral image under a same noise level. For example, in response to a determination that the type of the target spectral image is type a, and the noise level is 5, the first weight coefficient 615 and the second weight coefficient 616 may be equal to 0.5, respectively; in response to a determination that the type of the target spectral image is type b, and the noise level is 5, the first weight coefficient 615 may be equal to 0.8, and the second weight coefficient 616 may be equal to 0.2.

In some embodiments of the present disclosure, the weight coefficient(s) may be determined based on the required noise level or the type of the target spectral image, so that the target spectral image may be generated by comprehensively considering the noise level and the type of the target spectral image according to the actual needs of the user, thereby improving the user experience.

In some embodiments, the denoised spectral processing data may also be generated by using the first processing parameter to process noise-reduction spectral intermediate data. The noise-reduction spectral intermediate data may be generated based on the scan data or the set of sub-scan data.

Merely for illustration purposes, in response to a determination that the type of the target spectral image is the virtual monoenergetic image, the processing device may obtain the first processing parameter matching with the virtual monoenergetic image, and process the noise spectral intermediate data (e.g., the at least one noise spectral intermediate image) and the denoised spectral intermediate data (e.g., the at least one denoised spectral intermediate image) by using the first processing parameter, respectively, to generate the noise spectral processing data (e.g., the at least one noise processed image) and the denoised spectral processing data (e.g., the at least one denoised processed image). The processing device may also assign the first weight coefficient(s) to the noise spectral processing data (e.g., the at least one noise processed image), and assign the second weight coefficient(s) to the denoised spectral processing data (e.g., the at least one denoised processed image), respectively. The processing device may also perform the weighting operation on the noise spectral processing data (e.g., the at least one noise processed image) and the denoised spectral processing data (e.g., the at least one denoised processed image) based on the first weight coefficient(s) and the second weight coefficient(s) to generate a weighted image (e.g., a water-iodine-based material pair image). The processing device may further generate the target spectral image (i.e., the virtual monoenergetic image) by using an attenuation coefficient (e.g., a water-iodine mass attenuation coefficient) to process the weighted image (e.g., the water-iodine-based material pair image).

In some embodiments of the present disclosure, the first spectral processing data may be determined by using the first processing parameter to process the spectral intermediate data, and the target spectral image may be generated by performing the weighting operation on the first spectral processing data, so that the target spectral image may satisfy various requirements of the user.

In some embodiments, the first processing parameter may be related to the target noise level, and the processing device (e.g., the processing device 120 and the processor 210) may generate the target spectral image by performing a weighting operation on the spectral intermediate data based on the target noise level.

In some embodiments, the spectral intermediate data may include the noise spectral intermediate data (e.g., noise spectral intermediate data 611). The processing device may assign a plurality of third weight coefficients (not shown in the figure) to the noise spectral intermediate data, and generate the target spectral image by performing the weighting operation on the noise spectral intermediate data based on the third weight coefficients.

In some embodiments, the spectral intermediate data may include the denoised spectral intermediate data (e.g., denoised spectral intermediate data 612). The processing device may assign a plurality of fourth weight coefficients (not shown in the figure) to the denoised spectral intermediate data, and generate the target spectral image by performing the weighting operation on the denoised spectral intermediate data based on the fourth weight coefficients.

In some embodiments, the spectral intermediate data may include the noise spectral intermediate data (e.g., the noise spectral intermediate data 611) and the denoised spectral intermediate data (e.g., the denoised spectral intermediate data 612). The processing device may assign the plurality of third weight coefficients to the noise spectral intermediate data and the plurality of fourth weight coefficients (not shown in the figure) to the denoised spectral intermediate data, respectively, and generate the target spectral image by performing the weighting operation on the noise spectral intermediate data and the denoised spectral intermediate data based on the third weight coefficients and the fourth weight coefficients.

In some embodiments, the processing device may determine the third weight coefficients and/or the fourth weight coefficients based on the target noise level. The determination of a third weight coefficient and/or a fourth weight coefficient may be similar to the determination of a first weight coefficient and/or a second weight coefficient, which is not repeated herein.

In some embodiments of the present disclosure, the target spectral image may be generated based on the spectral intermediate data and the first processing parameter, thereby improving an accuracy and quality of the target spectral image.

It should be noted that the above description regarding process 600 is merely provided for the purposes of illustration, and not intended to limit the scope of the present disclosure. For those skilled in the art, various modifications and variations may be made for the process 600 under the guidance of the present disclosure. However, these modifications and variations do not depart from the scope of the present disclosure.

FIG. 7 is a flowchart illustrating an exemplary process for generating an effective atomic number image according to some embodiments of the present disclosure.

In some embodiments, a process 700 may be executed by the imaging system 100 (e.g., the processing device 120), the computing device 200 (e.g., the processor 210), or the first processing device 400. For example, the process 700 may be implemented as a set of instructions or an application stored in a storage device (e.g., the storage device 140). The processing device 120 may execute the set of instructions or the application and may accordingly be directed to perform the process 700.

In some embodiments, for each of one or more pixels corresponding to the target subject, an effective atomic number value of the pixel may be determined based on the spectral intermediate data, and the target spectral image may be generated based on one or more effective atomic number values of the one or more pixels. More details may be found in the following illustrations.

In 710, second spectral processing data may be determined by using a second processing parameter to process the spectral intermediate data. The second processing parameter in operation 710 may be similar to the first processing parameter in operation 610 of the process 600, and the second spectral processing data in operation 710 may be similar to the first spectral processing data in operation 620 of the process 600. More details may be found in FIG. 6 and related descriptions thereof, which is not repeated herein.

In 720, at least two weighted images may be generated by performing a weighting operation on the second spectral processing data. In some embodiments, the at least two weighted images may include a first weighted image and a second weighted image. Operation 720 may be similar to operation 620 of the process 600, and the at least two weighted images may be generated by performing at least two times of operation 620 of the process 600 based on at least two energy ranges. For example, the at least two weighted images may be at least two virtual monoenergetic images (e.g., at least two virtual monoenergetic CT images) corresponding to at least two energy ranges or energy levels. More details may be found in FIG. 6 and related descriptions thereof, which is not repeated herein.

In some embodiments, the first weighted image may correspond to a first energy range, the second weighted image may correspond to a second energy range, and a difference between a first energy value corresponding to the first weighted image in the first energy range and a second energy value corresponding to the second weighted image in the second energy range may satisfy a second preset condition. The second preset condition may include a preset threshold of an energy difference. In some embodiments, the first weighted image may correspond to a first energy level determined based on a first voltage (e.g., a low voltage), the second weighted image may correspond to a second energy level determined based on a second voltage (e.g., a high voltage), and a difference between the first level and the second energy level may satisfy a third preset condition. The third preset condition may be similar to the second preset condition, which is not repeated herein. In some embodiments, the first weighted image may include a first virtual monoenergetic image (also referred to as a first VMI image), and the second weighted image may include a second virtual monoenergetic image (also referred to as a second VMI image). More details of the energy range and the energy level may be found in FIG. 5 and the related descriptions thereof, which is not limited herein.

In some embodiments of the present disclosure, the difference between the first energy value corresponding to the first weighted image and the second energy value corresponding to the second weighted image may satisfy the second preset condition, so that different energy information may be separated to improve the quality of the target spectral image, which is conducive to qualitative and quantitative diagnosis of lesions and tissues of the target subject.

In 730, for each of one or more pixels corresponding to the target subject, an effective atomic number value of the pixel may be determined based on a first pixel value in the first weighted image, a second pixel value in the second weighted image, and a correction relationship. In some embodiments, operation 730 may be performed by the processing device 120 or the first determining module 420.

An atomic number of an unknown element may be calculated by X-ray attenuation. For a compound or mixture, if an attenuation effect of the compound or mixture is equivalent to a certain element, the atomic number of the element is referred to as an effective atomic number of the compound or mixture.

The correction relationship may be configured to determine the effective atomic number value of a pixel of the target subject. In some embodiments, the correction relationship may include a plurality of correction parameters.

In some embodiments, the plurality of correction parameters may be related to a device condition (e.g., an installation location, a power condition, a signal transmission condition, etc.), an environment factor (a temperature, a humidity, etc.), or the like.

In some embodiments, according to an imaging principle (e.g., a principle of CT imaging), the correction relationship may be represented by Formula (1) as below:

$$\frac{{CT}_{VMI \_ {1}^{st}} + 1000}{{CT}_{VMI \_ {2}^{nd}} + 1000} \approx \frac{1 + {C}_{L} {Z}_{eff}^{m - 1}}{{A}_{H} + {C}_{H} {Z}_{eff}^{m - 1}} , \qquad ( 1 )$$

where CT_{VMI_1}_{^{st}} denotes the first pixel value in the first weighted image, CT_{VMI_2}_{^{nd}} denotes the second pixel value in the second weighted image, Z_{eff}^{m-1} denotes the effective atomic number value of the pixel of the target subject, and C_{L}, A_{H}, m, and C_{H} denote the correction parameters.

In some embodiments, the plurality of correction parameters may be determined by scanning a reference subject. In some embodiments, the reference subject may include a phantom (e.g., a Gammex phantom) with known element composition. The phantom may be made of different materials that used to simulate different portions of a human body, such as bones, fat, liver, etc. That is, the materials used to make the phantom may correspond to different components of the human body. In some embodiments, a phantom supplier may provide elements used to make the phantom (e.g., carbon, hydrogen, or the like, may be labeled) and a mass fraction (i.e., a mass percentage of an element) of each element.

In some embodiments, the processing device (e.g., the processing device 120 and the processor 210) may determine a plurality of reference effective atomic number values corresponding to a plurality of reference pixels of the reference subject based on the reference subject, determine a plurality of reference correction relationships based on the plurality of reference effective atomic number values, and determine the plurality of correction parameters based on the plurality of reference correction relationships.

In some embodiments, an atomic number of a material to make the reference subject may be determined according to Formula (2) as below.

$${Z}_{eff} = \sqrt[β]{\frac{{Σ}_{i}^{n} \frac{{ω}_{i} {Z}_{i}}{{A}_{i}} {Z}_{i}^{β}}{{Σ}_{i}^{n} \frac{{ω}_{i} {Z}_{i}}{{A}_{i}}}} \qquad ( 2 )$$

where Z_{eff} denotes the effective atomic number value of the material made of the reference subject, Zᵢ denotes an atomic number of an i^{th} element of the material, i denotes a positive integer that is equal to or greater than one, n denotes a total count of elements of the material which is a positive integer equal to or greater than i, Aᵢ denotes an atomic mass of the i^{th} element of the material, ωᵢ denotes a mass fraction (i.e., a mass percentage) between Zᵢ and Aᵢ, and β denotes a real number that is determined according to actual needs. In some embodiments, ωᵢ may be provided by a manual of the reference subject, and β may be set to 2.94.

In some embodiments, the processing device may obtain at least two reference images of the reference subject by scanning the reference subject based on at least two energy ranges or energy levels. The at least two reference images of the reference subject may include a first reference image generated based on a first energy range or a first energy level, and a second reference image generated based on a second energy range or a second energy level. The first energy range or the first energy level may be different from the second energy range or the second energy level.

In some embodiments, the processing device may determine a plurality of first reference pixel values of the plurality of reference pixels in the first reference image, respectively. For example, the plurality of first reference pixel values may be represented as (CT1_{ref_VMI_1}_{^{st}}, CT2_{ref_VMI_1}_{^{st}} . . . CTn_{ref_VMI_1}_{^{st}}). The processing device may also determine a plurality of second reference pixel values of the plurality of reference pixels in the second reference image, respectively. For example, the plurality of second reference pixel values may be represented as (CT1_{ref_VMI_2}_{^{nd}}, CT2_{ref_VMI_2}_{^{nd}} . . . CTn_{ref_VMI_2}_{^{nd}}).

In some embodiments, the processing device may determine the plurality of reference effective atomic number values corresponding to the plurality of reference pixels of the reference subject by Formula (2), and the plurality of reference pixels may correspond to different materials made of the reference subject. For example, the plurality of reference effective atomic number values may be represented as (Z_{ref_eff}¹, Z_{ref_eff}² . . . Z_{ref_eff}ⁿ).

In some embodiments, the processing device may determine a plurality of reference correction relationships by using Formula (1) based on the plurality of reference effective atomic number values, the plurality of first reference pixel values, and the plurality of second reference pixel values. The plurality of reference correction relationships may correspond to a plurality of sets of correction parameters, respectively. For example, the plurality of sets of correction parameters may be represented as {(C_{L}¹, A_{H}¹, C_{H}¹, m₁), (C_{L}², A_{H}², C_{H}², m₂) . . . (C_{L}ⁿ, A_{H}ⁿ, C_{H}ⁿ, mₙ)}

In some embodiments, the processing device may determine the plurality of correction parameters based on the plurality of reference correction relationships corresponding to the plurality of sets of correction parameters, respectively.

In some embodiments of the present disclosure, the plurality of correction parameters may be related to the device condition, the environment factor, or the like, so that the generated target spectral image may be more in line with a real condition, thereby improving an accuracy of the target spectral image.

In some embodiments, the processing device may determine the plurality of correction parameters by performing at least one of a fitting-processing operation or a statistical computing operation on the plurality of reference correction relationships. For example, an equation group may be determined based on the plurality of reference correction relationships, and the plurality of correction parameters may be determined by solving the equation group. As another example, the plurality of correction parameters may be determined by performing the fitting-processing operation on the plurality of sets of correction parameters {(C_{L}¹, A_{H}¹, C_{H}¹, m₁), (C_{L}², A_{H}², C_{H}², m₂) . . . (C_{L}ⁿ, A_{H}ⁿ, C_{H}ⁿ, mₙ)} under a condition that the plurality of sets of correction parameters correspond to the plurality of reference correction relationships, respectively.

In some embodiments, the processing device may determine the effective atomic number value (e.g., Z_{eff}^{m-1}) of the pixel of the target subject by Formula (1) after the plurality of correction parameters (e.g., C_{L}, A_{H}, m, and C_{H}) are determined.

In some embodiments of the present disclosure, the plurality of correction parameters may be determined by performing at least one of the fitting-processing operation or the statistical computing operation on the plurality of reference correction relationships, so that a correction process may be easy to operate and have a high accuracy in a practical application, thereby achieving a support for a user interaction adjustment of an image quality of the target spectral image.

In some embodiments of the present disclosure, the plurality of reference effective atomic number values corresponding to the plurality of reference pixels of the reference subject may be determined based on the reference subject, the plurality of reference correction relationships may be determined based on the plurality of reference effective atomic number values, and the plurality of correction parameters may be determined based on the plurality of reference correction relationships, so that an accuracy of the plurality of correction parameters may be improved, thereby ensuring an accuracy of the calculated effective atomic number value of a pixel of the target subject.

It should be understood that the above description regarding a determination of the effective atomic number value of the pixel of the target subject is merely provided as an example. In some embodiments, the effective atomic number value of the pixel of the target subject may be determined through other manners, which is not limited herein.

In 740, the target spectral image may be generated based on one or more effective atomic number values of the one or more pixels of the target subject. The target spectral image may be an effective atomic number image. In some embodiments, operation 740 may be performed by the processing device 120 or the first generating module 430.

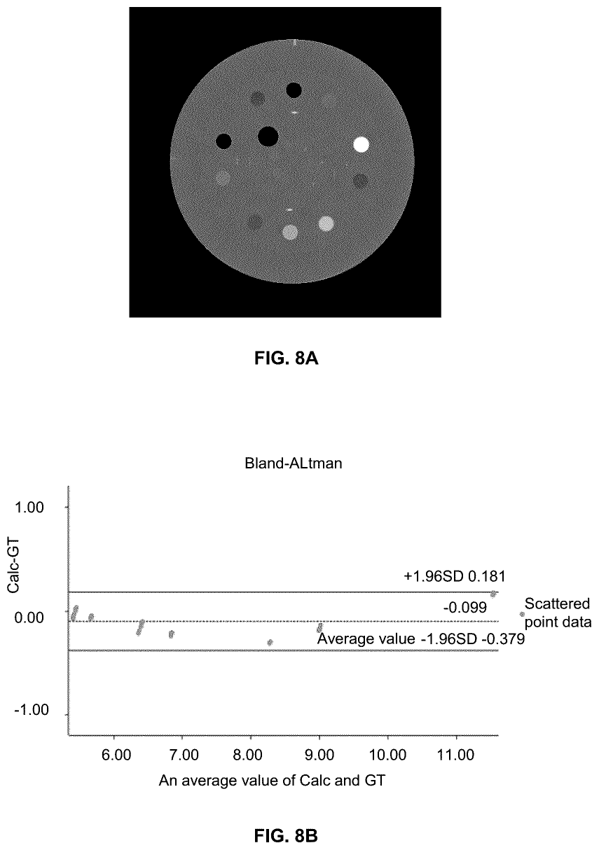

In some embodiments, an exemplary effective atomic number image may be as illustrated in FIG. 8A.

In some embodiments of the present disclosure, the target spectral image (i.e., the effective atomic numbering image) may be generated based on the one or more effective atomic number values of the one or more pixels of the target subject, thereby improving a quality and an accuracy of the target spectral image.

It should be noted that the above description regarding process 700 is merely provided for the purposes of illustration, and not intended to limit the scope of the present disclosure. For those skilled in the art, various modifications and variations may be made for the process 700 under the guidance of the present disclosure. However, these modifications and variations do not depart from the scope of the present disclosure.

FIG. 8B is a Bland-Altman diagram illustrating an accuracy of an effective atomic number value of a pixel of a target subject according to some embodiments of the present disclosure.

As illustrated in FIG. 8B, an x-coordinate may denote an average value of a reference effective atomic number value determined by Formula (2) and a calculated effective atomic number value determined by Formula (1), and a y-coordinate may denote a differential value of the reference effective atomic number value determined by Formula (2) and the calculated effective atomic number value determined by Formula (1). Scatter points with a greater differential value of the x-coordinate may correspond to different types of material, and scatter points with a small differential value of the x-coordinate may correspond to a same type of material. Two solid lines shown in FIG. 8B may denote an upper limit and a lower limit of a calculation error between the reference effective atomic number value and the calculated effective atomic number value, respectively. For a scatter point located between the two solid lines, the calculated effective atomic number value of the scatter point may have high consistency with the reference effective atomic number value, which indicates that the calculated effective atomic number value is accuracy.

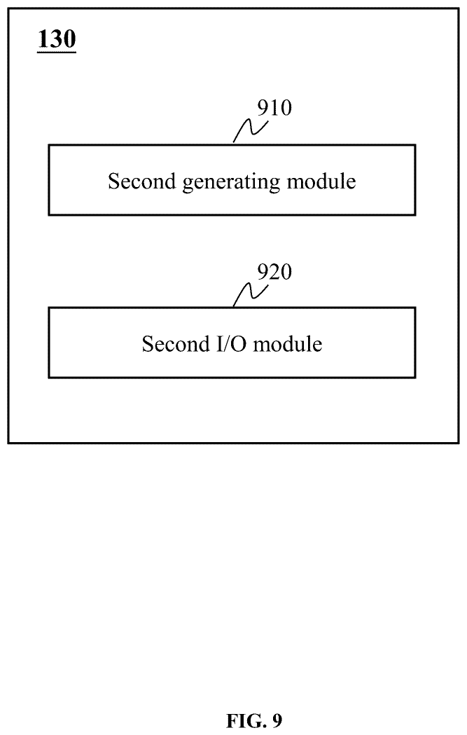

FIG. 9 is a block diagram illustrating an exemplary second processing device according to some embodiments of the present disclosure.

As illustrated in FIG. 9, in some embodiments, the second processing device 900 may include a second generating module 910 and a second Input/Output (I/O) module 920. In some embodiments, the second processing device 900 may be integrated in the terminal device 130 or the mobile device 300.

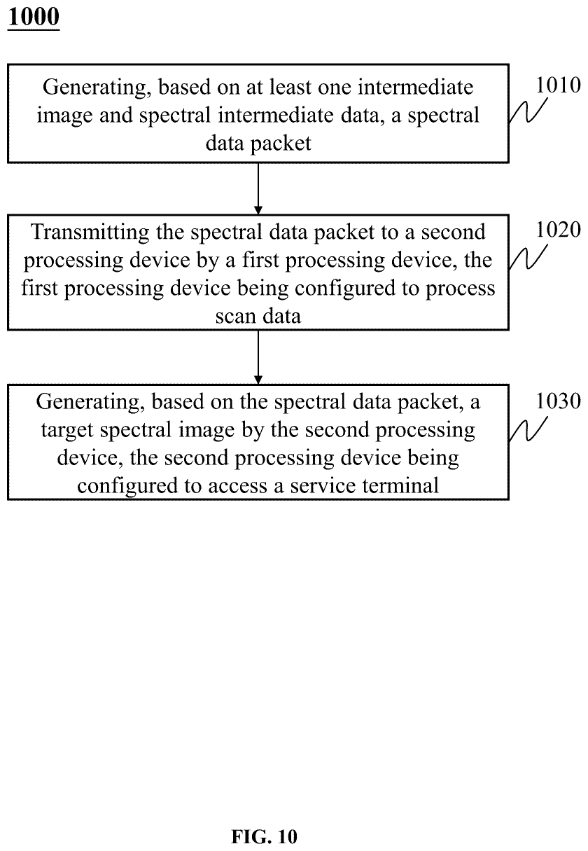

The second generating module 910 may be configured to generate a spectral data packet based on the at least one intermediate image and the spectral intermediate data. In some embodiments, the second generating module 910 may generate the spectral data packet by performing a packaging operation on the at least one intermediate image data and the spectral intermediate data. More descriptions for generating a spectral data packet based on the at least one intermediate image and the spectral intermediate data may be found elsewhere in the present disclosure (e.g., operation 1010 in FIG. 10 and descriptions thereof).

The second Input/Output (I/O) module 920 may be configured to transmit the spectral data packet to a second processing device by the first processing device. In some embodiments, the second Input/Output (I/O) module 920 may transmit the spectral data packet through a wired manner or a wireless manner. More descriptions for transmitting the spectral data packet to a second processing device may be found elsewhere in the present disclosure (e.g., operation 1020 in FIG. 10 and descriptions thereof).

The second generating module 910 may also be configured to generate the target spectral image by the second processing device based on the spectral data packet. More descriptions for generating the target spectral image by the second processing device based on the spectral data packet may be found elsewhere in the present disclosure (e.g., operation 1030 in FIG. 10 and descriptions thereof).

More details about the second generating module 910 and the second I/O module 920 may be found in FIG. 10 and the related descriptions thereof, which is not limited herein.

It should be noted that the above description of the modules and the second processing device 900 is intended to be illustrative, and not to limit the scope of the present disclosure. It should be understood that, for persons having ordinary skills in the art, each module may be combined arbitrarily, or form a subsystem to be connected with other modules under the teachings of the present disclosure. However, those variations and modifications do not depart from the scope of the present disclosure.

FIG. 10 is a flowchart illustrating an exemplary process for generating a target spectral image according to some embodiments of the present disclosure.

In some embodiments, a process 1000 may be executed by the imaging system 100 (e.g., the processing device 120), the mobile device 300, or the second processing device 900. For example, the process 1000 may be implemented as a set of instructions or an application stored in a storage device (e.g., the storage device 140). The processing device 120 may execute the set of instructions or the application and may accordingly be directed to perform the process 1000.

In 1010, a spectral data packet may be generated based on the at least one intermediate image and the spectral intermediate data. In some embodiments, operation 1010 may be performed by the processing device 120 or the second generating module 910. More details of the at least one intermediate image and the spectral intermediate data may be found in FIG. 5 and related descriptions thereof, which is not repeated herein.

In some embodiments, the spectral data packet may be generated by performing a packaging operation on the at least one intermediate image data and the spectral intermediate data. For example, the packaging operation may be implemented through a compressed tool.

In some embodiments, the spectral data packet may be represented in various packed formats. For example, the packed format of the spectral data packet may be a Binary format.

In some embodiments of the present disclosure, the at least one intermediate image and the spectral intermediate data may be packaged into the spectral data packet, so that the volume or the amount of the transmitted data used to generate the target spectral image may be greatly reduced, thereby improving a processing efficiency of the system 100 for spectral imaging.

In 1020, the spectral data packet may be transmitted to the second processing device 910 by the first processing device 410. In some embodiments, operation 1020 may be performed by the processing device 120 or the second I/O module 920.

In some embodiments, the first processing device 410 may transmit the spectral data packet to the second processing device 910 through a wired manner or a wireless manner. More details of the wired manner and the wireless manner may be found in FIG. 1 and the related descriptions thereof, which is not repeated herein. In some embodiments, the first processing device 410 may be configured to process the scan data. More details of the scan data may be found in FIG. 5 and the related descriptions thereof, which is not repeated herein.

In 1030, the target spectral image may be generated based on the spectral data packet by the second processing device 910. In some embodiments, operation 1030 may be performed by the processing device 120 or the second generating module 910. More details of the target spectral image may be found in FIG. 5 and related descriptions thereof, which is not repeated herein.

In some embodiments, the generation of the target spectral image based on the spectral data package may be similar to the generation of the target spectral image based on the spectral intermediate data, and more details of the generation of the target spectral image may be found in FIGS. 5, 6, and 7, and the related descriptions thereof, which is not limited herein.

In some embodiments, the second processing device 910 may obtain the target spectral image from the first processing device 410 directly. In some embodiments, the second processing device 910 may be configured to access a service terminal. For example, the second processing device 910 may include a Server Workstation, and the service terminal may include a ReconPC. In some embodiments, the service terminal may be the first processing device 410.

In some embodiments of the present disclosure, the first processing device 410 may transmit the spectral data packet to the second processing device 910, and the second processing device 910 may generate the target spectral image based on the spectral data packet, thereby achieving an effective transmission of data used to generate the target spectral image. Furthermore, a corresponding spectral imaging function can be realized on the first processing device 410 and the second processing device 910 simultaneously, which is convenient for the user to view the target spectral image at different locations.

It should be noted that the above description regarding process 1000 is merely provided for the purposes of illustration, and not intended to limit the scope of the present disclosure. For those skilled in the art, various modifications and variations may be made for process 1000 under the guidance of the present disclosure. However, these modifications and variations do not depart from the scope of the present disclosure.

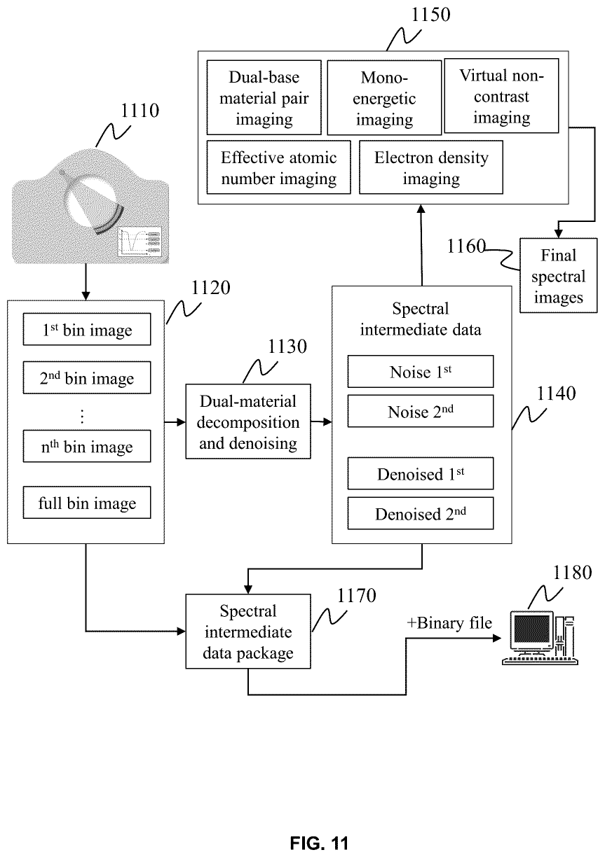

FIG. 11 is a schematic diagram illustrating an exemplary process for generating a target spectral image according to some embodiments of the present disclosure.

As illustrated in FIG. 11, in some embodiments, the scanner 110 may obtain the scan data of the target subject, and the first processing device 410 (e.g., the ReconPC 1110) may generate the at least one intermediate image 1120 (e.g., 1^{st} bin image, 2^{nd} bin image, . . . , n^{th} bin image, or a full bin image) based on the scan data by using the image reconstruction algorithm. The first processing device 410 (e.g., the ReconPC 1110) may determine the spectral intermediate data 1140 by performing the dual-material decomposition and denoising operation 1130 on the at least one intermediate image 1120. For example, as illustrated in FIG. 11, the spectral intermediate data 1140 may include two sets of spectral intermediate data, a first set of spectral intermediate data may include Noise 1^{st} spectral intermediate data and Denoised 1^{st} spectral intermediate data, and a second set of spectral intermediate data may include Noise 2^{nd} spectral intermediate data and Denoised 2^{nd} spectral intermediate data. The first processing device 410 (e.g., the ReconPC 1110) may generate target spectral images 1160 corresponding to various types of imaging function 1150. For example, as illustrated in FIG. 11, the types of imaging function 1150 may include the dual-base material pair imaging function, the mono-energetic imaging function, the virtual non-contrast imaging function, the effective atomic number imaging function, or the electron density imaging function.

In addition, as illustrated in FIG. 11, in some embodiments, the first processing device 410 (e.g., the ReconPC 1110) may generate the spectral data packet 1170 by performing the packaging operation on the at least one intermediate image 1120 and the spectral intermediate data 1140, and transmit the spectral data packet 1170 in the format of binary file to the second processing device 910 (e.g., the ServerWorkstation 1180), and the second processing device 910 (e.g., the ServerWorkstation 1180) may generate the target spectral images 1160 based on the spectral data packet 1170.

One or more embodiments of the present disclosure also provide a non-transitory computer readable medium storing instructions. The instructions, when executed by at least one processor, may cause the at least one processor to implement a method (e.g., the process 500 to the process 1100) illustrated above.

One or more embodiments of the present disclosure also provide a system for spectral imaging. The system may comprise at least one storage device storing a set of instructions, and at least one processor in communication with the storage device. When executing the set of instructions, the at least one processor may be configured to cause the system to perform operations 500.

A beneficial effect provided by the one or more embodiments of the present disclosure may include but not be limited to: (1) various types of a spectral image may be generated based on corresponding spectral intermediate data, so that various viewing requirements of the user may be satisfied; (2) a volume or an amount of data used to generated a required spectral image may be greatly reduced, so that an efficient data transmission may be achieved between different processing devices at different locations, which is convenient for the user to view the required spectral image; (3) a correction process of the required spectral image may be easy to operate, so that a support for a user interactive adjustment of a quality of the required spectral image may be achieved, thereby generating the required spectral image with a high accuracy and quality and facilitating the diagnosis and treatment of a disease.

It should be noted that the beneficial effect provided by different embodiments may be different. In different embodiments, a possible beneficial effect may be any one of the beneficial effect illustrated above, or a combination thereof, or a possible beneficial effect may be any beneficial effect that may be achieved.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, for example, an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities or properties used to describe and claim certain embodiments of the application are to be understood as being modified in some instances by the term “about,” “approximate,” or “substantially.” For example, “about,” “approximate,” or “substantially” may indicate ±1%, ±5%, ±10%, or ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustrative of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for spectral imaging implemented on a first processing device, the method comprising:
obtaining scan data of a target subject;
determining, based on the scan data, spectral intermediate data; and
generating, based on the spectral intermediate data, a target spectral image.

2. The method of claim 1, wherein the spectral intermediate data includes at least one of noise spectral intermediate data or denoised spectral intermediate data.

3. The method of claim 2, wherein a type of the target spectral image includes at least one of: a dual-base material pair image, a virtual monoenergetic image, a virtual non-contrast image, an electron density image, or an effective atomic number image.

4. The method of claim 3, wherein a volume of the noise spectral intermediate data or a volume of the denoised spectral intermediate data is related to the type of the target spectral image.

5. The method of claim 1, wherein the generating, based on the spectral intermediate data, the target spectral image includes:
obtaining a first processing parameter; and
generating, based on the spectral intermediate data and the first processing parameter, the target spectral image.

6. The method claim 5, wherein the first processing parameter is related to a target noise level, and the generating, based on the spectral intermediate data and the first processing parameter, the target spectral image includes:
generating the target spectral image by performing a weighting operation on the spectral intermediate data based on the target noise level.

7. The method of claim 5, wherein the first processing parameter is related to a type of the target spectral image, and the generating, based on the spectral intermediate data and the first processing parameter, the target spectral image includes:
determining first spectral processing data by using the first processing parameter to process the spectral intermediate data; and
generating the target spectral image by performing a weighting operation on the first spectral processing data.

8. The method of claim 1, wherein the generating, based on the spectral intermediate data, the target spectral image includes:
for each of one or more pixels corresponding to the target subject, determining, based on the spectral intermediate data, an effective atomic number value of the pixel; and
generating, based on one or more effective atomic number values of the one or more pixels, the target spectral image.

9. The method of claim 8, wherein the generating, based on one or more effective atomic number values of the one or more pixels, the target spectral image includes:
determining second spectral processing data by using a second processing parameter to process the spectral intermediate data;
generating at least two weighted images by performing a weighting operation on the second spectral processing data, the at least two weighted images include a first weighted image and a second weighted image;
for the each of one or more pixels corresponding to the target subject, determining the effective atomic number value of the pixel based on a first pixel value in the first weighted image, a second pixel value in the second weighted image, and a correction relationship; and
generating, based on the one or more effective atomic number values of the one or more pixels, the target spectral image, the target spectral image being an effective atomic number image.

10. The method of claim 9, wherein a difference between a first energy value corresponding to the first weighted image and a second energy value corresponding to the second weighted image satisfies a preset condition.

11. The method of claim 9, wherein the correction relationship includes a plurality of correction parameters, and the plurality of correction parameters are determined by:
determining, based on a reference subject, a plurality of reference effective atomic number values corresponding to a plurality of reference pixels of the reference subject;
determining, based on the plurality of reference effective atomic number values, a plurality of reference correction relationships; and
determining, based on the plurality of reference correction relationships, the plurality of correction parameters.

12. The method of claim 11, wherein the determining, based on the plurality of reference correction relationships, the plurality of correction parameters includes:
determining the plurality of correction parameters by performing at least one of a fitting-processing operation or a statistical computing operation on the plurality of reference correction relationships.

13. The method of claim 1, further including:
generating, based on at least one intermediate image and the spectral intermediate data, a spectral data packet;
transmitting the spectral data packet to a second processing device by the first processing device, the first processing device being configured to process the scan data; and
generating, based on the spectral data packet, the target spectral image by the second processing device, the second processing device being configured to access a service terminal.

14. A system for spectral imaging, comprising:
at least one storage device storing a set of instructions; and
at least one processor in communication with the storage device, wherein when executing the set of instructions, the at least one processor is configured to cause the system to perform operations including:
obtaining scan data of a target subject;
determining, based on the scan data, spectral intermediate data; and
generating, based on the spectral intermediate data, a target spectral image.

15. The system of claim 1, wherein to generate, based on the spectral intermediate data, the target spectral image, the at least one processor is configured to cause the system to perform operations including:
obtaining a first processing parameter; and
generating, based on the spectral intermediate data and the first processing parameter, the target spectral image.

16. The system claim 15, wherein the first processing parameter is related to a target noise level, and to generate, based on the spectral intermediate data and the first processing parameter, the target spectral image, the at least one processor is configured to cause the system to perform operations including:
generating the target spectral image by performing a weighting operation on the spectral intermediate data based on the target noise level.

17. The system of claim 15, wherein the first processing parameter is related to a type of the target spectral image, and to generate, based on the spectral intermediate data and the first processing parameter, the target spectral image, the at least one processor is configured to cause the system to perform operations including:
determining first spectral processing data by using the first processing parameter to process the spectral intermediate data; and
generating the target spectral image by performing a weighting operation on the first spectral processing data.

18. The system of claim 14, wherein to generate, based on the spectral intermediate data, the target spectral image, the at least one processor is configured to cause the system to perform operations including:
for each of one or more pixels corresponding to the target subject, determining, based on the spectral intermediate data, an effective atomic number value of the pixel; and
generating, based on one or more effective atomic number values of the one or more pixels, the target spectral image.

19. The system of claim 18, wherein to generate, based on one or more effective atomic number values of the one or more pixels, the target spectral image, the at least one processor is configured to cause the system to perform operations including:
determining second spectral processing data by using a second processing parameter to process the spectral intermediate data;
generating at least two weighted images by performing a weighting operation on the second spectral processing data, the at least two weighted images include a first weighted image and a second weighted image;
for the each of one or more pixels corresponding to the target subject, determining the effective atomic number value of the pixel based on a first pixel value in the first weighted image, a second pixel value in the second weighted image, and a correction relationship; and
generating, based on the one or more effective atomic number values of the one or more pixels, the target spectral image, the target spectral image being an effective atomic number image.

20. A non-transitory computer readable medium storing instructions, the instructions, when executed by at least one processor, causing the at least one processor to implement a method, the method comprising:
obtaining scan data of a target subject;
determining, based on the scan data, spectral intermediate data; and
generating, based on the spectral intermediate data, a target spectral image.
